(19) United States
(12) Patent Application Publication
(10) Pub. No.: US 2025/0216512 A1
(43) Pub. Date: Jul. 3, 2025

(54) SURFACE EMITTING LASER-BASED DEVICE FOR LIGHT DETECTION AND RANGING

(71) Applicant: Apple Inc., Cupertino, CA (US)

(72) Inventors: Fei Tan, Sunnyvale, CA (US); Nurul Islam, Cupertino, CA (US); Keith Lyon, San Jose, CA (US); Chin-Han Lin, Santa Clara, CA (US); Pengfei Qiao, El Cerrito, CA (US); Alexander Hein, Munich, Bavaria-Bayern (DE)

(21) Appl. No.: 18/985,831

(22) Filed: Dec. 18, 2024

Related U.S. Application Data
(60) Provisional application No. 63/614,555, filed on Dec. 23, 2023.

(51) Int. Cl. G01S 7/481

(52) U.S. Cl. CPC G01S 7/4811; G01S 7/4815

(57) ABSTRACT

A device is described that includes a lens, a photonic substrate, and a surface emitting laser mounted and a set of photodetectors mounted on the photonic substrate. The photonic substrate includes a first surface coupler, a second surface coupler, and an interference coupler. The surface emitting laser emits electromagnetic radiation that is modulated according to a continuous wave frequency modulation. The first surface coupler directs a local oscillator portion of the electromagnetic radiation toward the set of photodetectors. The second surface coupler directs, toward the set of photodetectors, a signal portion of the electromagnetic radiation that is reflected from a target and received via the lens. The interference coupler optically interferes the local oscillator portion from the first surface coupler with the signal portion from the second surface coupler to generate a set of optical outputs that are provided to the set of photodetectors.

### CROSS-REFERENCE TO RELATED APPLICATIONS

This application is a nonprovisional and claims the benefit under 35 U.S.C. § 119 (e) of U.S. Provisional Patent Application No. 63/614,555, filed Dec. 23, 2023, the contents of which are incorporated herein by reference as if fully disclosed herein.

### FIELD

The described embodiments generally relate to electronic devices and, more particularly, to surface emitting laser-based devices for light detection and ranging.

### BACKGROUND

Modern consumer electronic devices take many shapes and forms and have numerous uses and functions. Smartphones, wearables devices, including wrist-worn devices (e.g., watches or fitness tracking devices) and head-mounted devices (e.g., headsets, glasses, or earbuds), hand-held devices (e.g., styluses, electronic pencils, or communication or navigation devices), computers (e.g., tablet computers or laptop computers), and dashboards, for example, provide various ways for users to interact with others. Such devices may include numerous systems to facilitate such interactions. For example, a smartphone or computer may include a touch-sensitive display for accepting touch or force inputs and providing a graphical output, and many types of electronic devices may include wireless communications systems (e.g., for connecting with other devices to send and receive voice and data content); one or more cameras (e.g., for capturing photographs and videos); or one or more buttons (e.g., depressible buttons, rocker buttons, or crowns (rotatable buttons) that a user may press or otherwise manipulate to provide input to an electronic device).

### SUMMARY

The term embodiment and like terms (e.g., implementation, configuration, aspect, example, and option) are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, the drawings, and each claim.

Some aspects of this disclosure are directed to a device that includes a lens, a photonic substrate, a surface emitting laser mounted on the photonic substrate, and a set of photodetectors. The photonic substrate includes a first surface coupler, a second surface coupler, and an interference coupler. The surface emitting laser emits electromagnetic radiation that is modulated according to a continuous wave frequency modulation. The first surface coupler directs a local oscillator portion of the electromagnetic radiation toward the set of photodetectors. The second surface coupler directs, toward the set of photodetectors, a signal portion of the electromagnetic radiation that is reflected from a target and received via the lens. The interference coupler optically interferes the local oscillator portion of the electromagnetic radiation from the first surface coupler with the signal portion of the electromagnetic radiation from the second surface coupler to generate a set of optical outputs that are provided to the set of photodetectors.

Some aspects of this disclosure are directed to another device that includes a photonic substrate including a plurality of couplers, a plurality of photodetectors, a plurality of surface emitting lasers mounted to the photonic substrate, and a lens coupled to the photonic substrate. The plurality of surface emitting lasers emit electromagnetic radiation that is modulated according to a continuous wave frequency modulation. The lens is configured to direct a signal portion of the electromagnetic radiation reflected from a target toward the photonic substrate. The photonic substrate is configured, for each surface emitting laser of the plurality of surface emitting lasers, to direct, via a first surface coupler of the plurality of couplers, a local oscillator portion of the electromagnetic radiation from the surface emitting laser toward a set of photodetectors of the plurality of photodetectors. The photonic substrate is further configured, for each surface emitting laser of the plurality of surface emitting lasers, to direct, via a second surface coupler of the plurality of couplers, the signal portion of the electromagnetic radiation toward the set of photodetectors. The photonic substrate is further configured, for each surface emitting laser of the plurality of surface emitting lasers, to optically interfere, at an interference coupler of the plurality of couplers, the local oscillator portion of the electromagnetic radiation with the signal portion of the electromagnetic radiation to generate a set of optical outputs that are received at the set of photodetectors.

Some aspects of this disclosure are directed to another device for light detection and ranging. The device includes a lens to direct a signal portion of electromagnetic radiation reflected from a target, and an array of unit cells. Each unit cell of the array of unit cells includes: a surface emitting laser mounted on a portion of a photonic substrate, the surface emitting laser to emit the electromagnetic radiation that is modulated according to a continuous wave frequency modulation; a set of photodetectors for the portion of the photonic substrate; a first surface coupler formed in the portion of the photonic substrate, the first surface coupler to direct a local oscillator portion of the electromagnetic radiation from the surface emitting laser toward the set of photodetectors; a second surface coupler formed in the portion of the photonic substrate, the second surface coupler to direct the signal portion of the electromagnetic radiation reflected from the target toward the set of photodetectors; and an interference coupler formed in the portion of the photonic substrate, the interference coupler to optically interfere the local oscillator portion of the electromagnetic radiation with the signal portion of the electromagnetic radiation to generate a set of optical outputs to provide to the set of photodetectors.

Still other aspects are directed to a device that includes a photonic substrate, a surface emitting laser mounted, and a set of photodetectors. The photonic substrate includes a first surface coupler, a second surface coupler, and an interference coupler. The surface emitting laser is mounted on the photonic substrate, and is configured to emit polarized light having a first polarization. The surface emitting laser is positioned to emit the polarized light having a first toward the photonic substrate. The first surface coupler is positioned to capture a first portion of the polarized light as local oscillator light and pass a second portion of the polarized light that exits the photonic substrate as emitted signal light. The second surface coupler is positioned to receive reflected signal light that is reflected and capture a portion of the reflected signal light having a second polarization as collected signal light. The interference coupler optically interferes the local oscillator light with the collected signal light to generate a set of optical outputs, and the set of photodetectors measures the set of optical outputs.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the described embodiments, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A and 1B show a front isometric view and a rear isometric view, respectively, of an example electronic device, according to certain aspects of the present disclosure.

FIG. 2 shows an example block diagram, which may include a device incorporating surface emitting laser-based devices for light detection and ranging, according to certain aspects of the present disclosure.

FIG. 3 shows an example device, which may be a surface emitting laser-based device for light detection and ranging, according to certain aspects of the present disclosure.

FIG. 4 shows an example device, which may be a surface emitting laser-based device for light detection and ranging, according to certain aspects of the present disclosure.

FIG. 5 shows an example device, which may be a surface emitting laser-based device for light detection and ranging, according to certain aspects of the present disclosure.

FIGS. 6A and 6B show a side view and a top view, respectively, of an example device, which may be a surface emitting laser-based device for light detection and ranging, according to certain aspects of the present disclosure.

FIG. 7 shows an example method, according to one or more aspects described herein.

FIG. 8 shows another example method, according to one or more aspects described herein.

FIG. 9 shows an example electrical block diagram of an electronic device having a light detection and ranging device, such as one of the surface emitting laser-based devices for light detection and ranging described herein, including systems for light detection and ranging incorporating such devices.

FIG. 10A shows an example device, which may be a surface emitting laser-based device for light detection and ranging, according to certain aspects of the present disclosure. FIG. 10B shows a cross-sectional side view of a portion of the device of FIG. 10A.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

The present disclosure is susceptible to various modifications and alternative forms, and some representative embodiments have been shown by way of example in the drawings and will be described in detail herein. It should be understood, however, that the described embodiments are not intended to be limited to the particular forms disclosed. Rather, the disclosure is to cover all modifications, equivalents, and alternatives falling within the spirit and scope of the described embodiments as defined by the appended claims.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Various embodiments are described with regard to a consumer electronics device, such as a smartphone, wearable device, hand-held device, computer, or dashboard. However, reference to a consumer electronics device, or a particular type of consumer electronics device, is merely provided for illustrative purposes. The example embodiments may be utilized with, include, or be included in any electronic system, device, or component described herein. Therefore, the electronic device described herein is used to represent any appropriate electronic device.

Light detection and ranging (LIDAR), is a remote sensing technology that uses laser light to measure distances and create detailed, three-dimensional maps of the surroundings. LIDAR generally operates on the principle of sending laser pulses and measuring the time it takes for the light to return after reflecting off one or more objects, which may also generally be referred to as a “target.” By analyzing the returned signals, LIDAR systems can generate highly accurate and precise data about the shape, distance, and even surface characteristics of objects in the field of view. LIDAR is widely used in various applications, and can provide detailed and real-time spatial information for precise mapping and object detection.

Frequency modulate continuous-wave (FMCW) radar is a remote sensing technology, which may be commonly used for distance and speed measurements. FMCW radar involves the emission of a continuous signal (e.g., signal light) with a frequency that changes linearly over time. The emitted signal reflects off objects in the path of the signal light, and the frequency shift between the transmitted and received signals is analyzed to determine the distance to the target (a range), as well as a velocity of the target. Continuous operation may allow for FMCW radar to provide accurate and real-time information, which may be used for applications such as, but not limited to, automotive collision avoidance systems, radar altimeters, and industrial sensing applications.

FMCW is a powerful tool to obtain high resolution spatial information of targets with lower photon energy than a time-of-flight method. Existing FMCW techniques may use edge emitting lasers (EELs) for FMCW. Techniques using EELs have several drawbacks, including a high cost of integrating the EEL with silicon photonics, and challenges in accurate alignment to couple light for the EEL to silicon photonic waveguides. As such a lower cost solution using semiconductor (e.g., silicon, including silicon (Si) or silicon nitride (SiNx)) photonic substrates or polymer photonic substrates (e.g., printed circuit board (PCB)) are desired for FMCW radar, including FMCW LIDAR (e.g., a LIDAR system that utilizes FMCW sensing).

As further described herein, devices for light detection and ranging are described that include a lens, a photonic substrate, and a surface emitting laser (SEL) mounted on a photonic substrate, and a set of photodetectors, which may be mounted on the photonic substrate or integrated into the photonic substrate. The photonic substrate includes a first surface coupler, a second surface coupler, and an interference coupler. The first surface coupler and the second surface coupler may be grating couplers in some examples. In other examples, the first surface coupler and the second surface coupler may be wedge couplers. The surface emitting laser emits electromagnetic radiation (light, which may be visible or in the non-visible spectrum) that is modulated according to a continuous wave frequency modulation. The first surface coupler directs a local oscillator portion of the electromagnetic radiation toward the set of photodetectors. The second surface coupler directs, toward the set of photodetectors, a signal portion of the electromagnetic radiation that is reflected from a target and received via the lens. The interference coupler optically interferes the local oscillator portion from the first surface coupler with the signal portion from the second surface coupler to generate a set of optical outputs that are provided to the set of photodetectors.

In some embodiments, the first surface coupler may receive light emitted from the SEL, and the signal light may be both transmitted away from the device and received back at the device via the second surface coupler. In other embodiments, the first surface coupler may receive light emitted from the SEL, and the signal light may be transmitted away from the device using the first surface coupler, which also redirects a portion of the light emitted by the SEL as local oscillator (LO) light. The signal light is received back at the device via the second surface coupler. In yet other embodiments, the SEL is a dual-emitting SEL, where the signal light is emitted away from the device in a first direction from the SEL and the LO light is emitted toward the photonic substrate and the first surface coupler. The signal light is received back at the device via the second surface coupler.

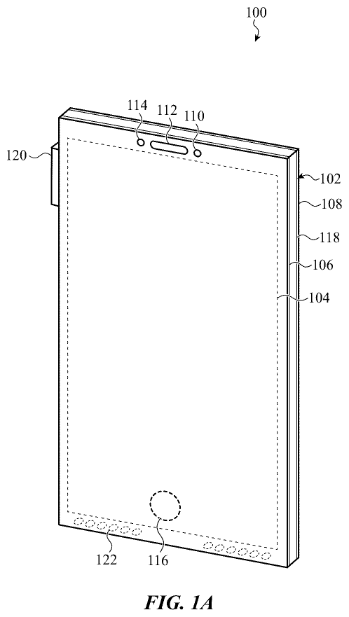

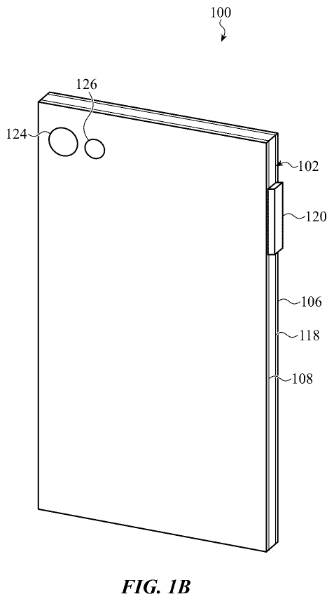

These and other embodiments are discussed below with reference to FIGS. 1A-10B. However, those skilled in the art will readily appreciate that the detailed description given herein with respect to these figures is for explanatory purposes only and should not be construed as limiting.

FIG. 1A shows a front isometric view of a device 100, and FIG. 1B shows a rear isometric view of the device 100. Device 100 may include an image sensor or depth sensor. The device's dimensions and form factor, including the ratio of the length of its long sides to the length of its short sides, suggest that the device 100 is a mobile phone (e.g., a smartphone). However, the device's dimensions and form factor are arbitrarily chosen, and the device 100 could alternatively be any portable electronic device including, for example a mobile phone, tablet computer, portable computer, portable music player, wearable device (e.g., an electronic watch, health monitoring device, or fitness tracking device), augmented reality (AR) device, virtual reality (VR) device, mixed reality (MR) device, gaming device, portable terminal, digital single-lens reflex (DSLR) camera, video camera, vehicle navigation system, robot navigation system, or other portable or mobile device. The device 100 could also be a device that is semi-permanently located (or installed) at a single location. The device 100 may include a housing 102 that at least partially surrounds a display 104. The housing 102 may include or support a front cover 106 or a rear cover 108. The front cover 106 may be positioned over the display 104, and may provide a window through which the display 104 may be viewed. In some embodiments, the display 104 may be attached to (or abut) the housing 102 and/or the front cover 106. In alternative embodiments of the device 100, the display 104 may not be included and/or the housing 102 may have an alternative configuration.

The display 104 may include one or more light-emitting elements, and in some cases may be a light-emitting diode (LED) display, an organic LED (OLED) display, a liquid crystal display (LCD), an electroluminescent (EL) display, or another type of display. In some embodiments, the display 104 may include, or be associated with, one or more touch and/or force sensors that are configured to detect a touch and/or a force applied to a surface of the front cover 106.

The various components of the housing 102 may be formed from the same or different materials. For example, a sidewall 118 of the housing 102 may be formed using one or more metals (e.g., stainless steel), polymers (e.g., plastics), ceramics, or composites (e.g., carbon fiber). In some cases, the sidewall 118 may be a multi-segment sidewall including a set of antennas. The antennas may form structural components of the sidewall 118. The antennas may be structurally coupled (to one another or to other components) and electrically isolated (from each other or from other components) by one or more non-conductive segments of the sidewall 118. The front cover 106 may be formed, for example, using one or more of glass, a crystal (e.g., sapphire), or a transparent polymer (e.g., plastic) that enables a user to view the display 104 through the front cover 106. In some cases, a portion of the front cover 106 (e.g., a perimeter portion of the front cover 106) may be coated with an opaque ink to obscure components included within the housing 102. The rear cover 108 may be formed using the same material(s) that are used to form the sidewall 118 or the front cover 106. In some cases, the rear cover 108 may be part of a monolithic element that also forms the sidewall 118 (or in cases where the sidewall 118 is a multi-segment sidewall, those portions of the sidewall 118 that are conductive or non-conductive). In still other embodiments, all of the exterior components of the housing 102 may be formed from a transparent material, and components within the device 100 may or may not be obscured by an opaque ink or opaque structure within the housing 102.

The front cover 106 may be mounted to the sidewall 118 to cover an opening defined by the sidewall 118 (i.e., an opening into an interior volume in which various electronic components of the device 100, including the display 104, may be positioned). The front cover 106 may be mounted to the sidewall 118 using fasteners, adhesives, seals, gaskets, or other components.

A display stack or device stack (hereafter referred to as a “stack”) including the display 104 may be attached (or abutted) to an interior surface of the front cover 106 and extend into the interior volume of the device 100. In some cases, the stack may include a touch sensor (e.g., a grid of capacitive, resistive, strain-based, ultrasonic, or other type of touch sensing elements), or other layers of optical, mechanical, electrical, or other types of components. In some cases, the touch sensor (or part of a touch sensor system) may be configured to detect a touch applied to an outer surface of the front cover 106 (e.g., to a display surface of the device 100).

In some cases, a force sensor (or part of a force sensor system) may be positioned within the interior volume above, below, and/or to the side of the display 104 (and in some cases within the device stack). The force sensor (or force sensor system) may be triggered in response to the touch sensor detecting one or more touches on the front cover 106 (or a location or locations of one or more touches on the front cover 106), and may determine an amount of force associated with each touch, or an amount of force associated with a collection of touches as a whole. In some embodiments, the force sensor (or force sensor system) may be used to determine a location of a touch, or a location of a touch in combination with an amount of force of the touch. In these latter embodiments, the device 100 may not include a separate touch sensor.

The device 100 may include various other components. For example, the front of the device 100 may include one or more front-facing cameras 110 (including one or more image sensors or depth sensors, which in some cases may include one or more of the SEL-based LIDAR devices described herein), speakers 112, microphones, or other components 114 (e.g., audio, imaging, and/or sensing components) that are configured to transmit or receive signals to/from the device 100. In some cases, a front-facing camera 110, alone or in combination with other sensors, may be configured to operate as a bio-authentication or facial recognition sensor. In some embodiments, a flash or electromagnetic radiation source (e.g., a visible or IR light source) may be positioned near the front-facing camera. In some cases, the front-facing camera 110 may be positioned behind the display 104 and receive electromagnetic radiation (e.g., light) through the display 104. In some cases, a depth sensor may be used to determine a distance to a user or generate a depth map of the user's face, or determine a distance or proximity to an object, or generate a depth map of the object or a field of view (FoV) that includes the object. The device 100 may also include various input devices, including a mechanical or virtual button 116, which may be accessible from the front surface (or display surface) of the device 100.

The device 100 may also include buttons or other input devices positioned along the sidewall 118 and/or on a rear surface of the device 100. For example, a volume button or multipurpose button 120 may be positioned along the sidewall 118, and in some cases may extend through an aperture in the sidewall 118. The sidewall 118 may include one or more ports 122 that allow air, but not liquids, to flow into and out of the device 100. In some embodiments, one or more sensors may be positioned in or near the port(s) 122. For example, an ambient pressure sensor, ambient temperature sensor, internal/external differential pressure sensor, gas sensor, particulate matter concentration sensor, or air quality sensor may be positioned in or near a port 122.

In some embodiments, the rear surface of the device 100 may include a rear-facing camera 124 that includes one or more image sensors or depth sensors, which in some cases may include one or more of the SEL-based LIDAR devices described herein. A flash or electromagnetic radiation source 126 (e.g., a visible or IR light source) may also be positioned on the rear of the device 100 (e.g., near the rear-facing camera). In some cases, the rear surface of the device 100 may include multiple rear-facing cameras.

Various examples of electronic devices are described with reference to device 100 that make use of emitted light and received reflections for sensing an exterior environment and objects therein. However, one of ordinary skill in the art will recognize that other types and categories of electronic devices may also make use of emitted light and received reflections for sensing, and that the embodiments disclosed herein are not limited to any particular type or category of electronic device.

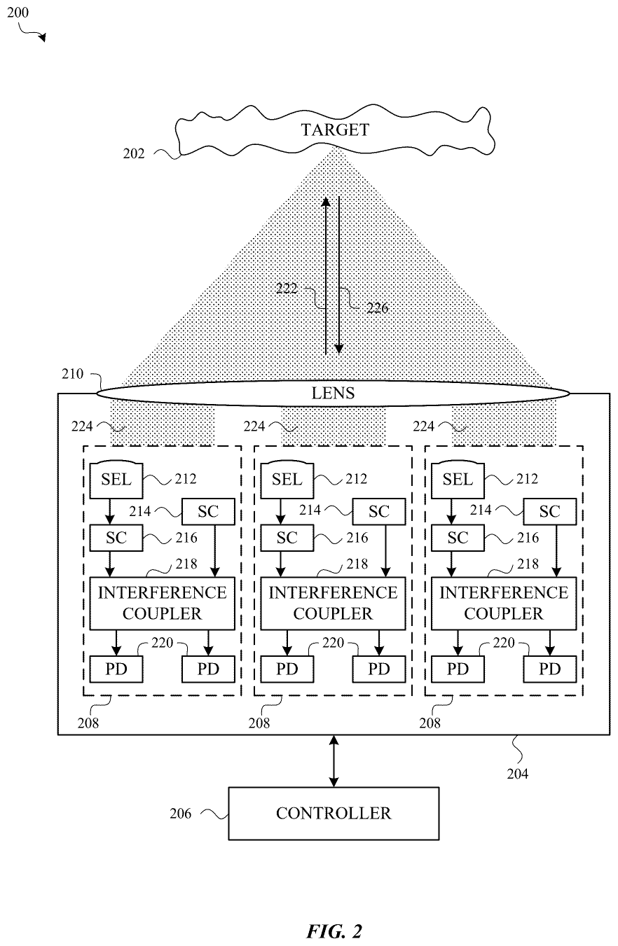

FIG. 2 shows an example block diagram 200, which may include a device incorporating surface emitting laser-based devices for light detection and ranging, according to certain aspects of the present disclosure. Block diagram 200 includes a simplified diagram of a device 204, which may be or be a portion of a LIDAR device or system. Device 204 may be or include one or more of the various SEL-based LIDAR devices disclosed herein. The device 204 may be used to detect distances to objects in an exterior environment, such as a tree, vehicle, or building. The device 204 may use the detected distances to form a depth map or other image or images of the exterior environment. The device 204 may be handheld, mounted to a handheld mobile or other electronic device such as device 100, mounted to a stationary object, or carried by a moving vehicle or airplane.

The device 204 may emit light 222 directionally toward a target 202, which may also be referred to as an object and may include multiple targets or objects. In the particular case shown in block diagram 200, the device 204 may emit sequentially within a first plane multiple light pulses as a first set of light pulses, followed by sequentially emitting within a second plane a second set of light pulses. In some cases the first plane is perpendicular to the second plane. Additionally, the device 204 may emit light pulses across more planes, or planes oriented at angles other than 90 degrees to each other. The light pulses may be laser pulses 224, such as may be emitted from one or more laser diodes within the device 204, such as one or more of SEL 212. The plane of an emitted laser pulse 224 and the direction within the plane may be controlled by mechanisms (not shown) within the device 204, such as steerable optics, or by sequential emission of the laser pulses from an array of laser diodes in which the laser diodes are aimed at different directions to allow sweeping, both vertically and horizontally, of the exterior environment.

The device 204 may receive reflections 226 of the emitted light pulses, such as by one or more photodetectors 220, which may be in an array. The photodetectors may be implemented in one or more of various technologies, such as waveguide photodiodes, resonant cavity photodiodes, single photon avalanche diodes, complementary metal-oxide-semiconductor (CMOS) photodetectors, or another technology.

The device 204 may use FMCW techniques to measure directional distance, depth map, and velocity.

In one or more embodiments, the device 204, includes a lens 210 and a plurality of unit cells 208, which may be arranged as an array of unit cells 208. Each unit cell 208 may be associated with a portion or area of a photonic substrate, where the first surface coupler 216, the second surface coupler 214, and the interference coupler 218 are formed in or on the photonic substrate, and the SEL 212 and photodetectors are for the photonic substrate within the portion or area. In some embodiments, the photodetectors are integrated (e.g., at least partially embedded) within the photonic substrate of the unit cell 208. In other embodiments, the photodetectors may be mounted on the photonic substrate. The array of unit cells 208 may be a grid, or other regular pattern or structure, or an irregular arrangement. While a single lens 210 is illustrated for device 204, two or more lenses, a stack of lenses, or another lens assembly may be used consistent with the disclosure herein.

Each unit cell 208 includes an SEL 212, a first surface coupler 216, a second surface coupler 214, an interference coupler 218, and set of photodetectors 220. In some embodiments, the first surface coupler 216, the second surface coupler 214, and the interference coupler 218 are formed in or otherwise integrated into a photonic substrate. The photonic substrate includes optical waveguides that generally direct the energy of the electromagnetic radiation to propagate in a plane parallel to the plane of the photonic substrate. That is, the photonic substrate uses optical waveguides formed within the photonic substrate to direct light in a desired direction. Electromagnetic radiation may also be referred to as “light” herein, for example electromagnetic radiation having a frequency in the visible, ultraviolet, or infrared ranges.

The first surface coupler 216 and the second surface coupler 214 generally direct away or toward the photonic substrate. For example first surface coupler 216 may receive light that is generally directed toward the face of the photonic substrate, for example light generally propagating in a direction more perpendicular to the plane of the photonic substrate (e.g., from SEL 212) than parallel to the plane of the photonic substrate, and direct a propagation of the light (e.g., via a waveguide of the photonic substrate) to be in a direction more parallel to the plane of the photonic substrate than perpendicular. Such light may be referred to as “local oscillator” light as further discussed herein. Second surface coupler 214 may also receive light that is perpendicular to the photonic substrate (e.g., signal light reflected from the target 202) and direct a propagation of the light to be in a direction more parallel to the plane of the photonic substrate (e.g., via a waveguide of the photonic substrate). Such light may be or be referred to as collected signal light as further discussed herein.

Light from the first surface coupler 216 and light from the second surface coupler 214 are directed toward an interference coupler 218 via a set of waveguides. As further discussed herein, one or more additional optical components or sets of waveguides may be within the optical path between the first surface coupler 216 and the interference coupler 218, and between the second surface coupler 214 and the interference coupler 218. The light (e.g., the collected signal light and the local oscillator light) is brought in proximity within an active region of the interference coupler and interacts (e.g., interferes according to known optical principles) to produce a set of optical outputs, which are then directed toward the set of photodetectors 220. In an example, the interference coupler 218 has two inputs to receive the signal and LO signals and two outputs that are coupled with two photodetectors (e.g., balanced photodetectors), respectively.

In one or more embodiments, the photodetectors of the set of photodetectors 220 are surface mounted on the photonic substrate. In other embodiments, the photodetectors of the set of photodetectors 220 are integrated within the photonic substrate (e.g., each photodetector is a silicon photonics device at least partially embedded within the photonic substrate). Accordingly, the set of photodetectors 220 may also be associated with a set of surface couplers for the photodetectors, specifically to couple the outputs of the interference coupler 218, which each may be propagated via a waveguide, to the sensing portion of the photodetectors of the set of photodetectors 220. In some examples, the surface couplers for the photodetectors may direct each optical output from the interference coupler 218 to be generally perpendicular to the surface of the photonic substrate and propagate toward the sensing portion of a photodetector of the set of photodetectors 220.

The second surface coupler 214 generally receives signal light reflected from a target (e.g., objects). The signal light may be propagated away from the device 204 according to different designs or techniques, which are further described herein. In a first device, the emitted signal light to output from the device 204 is directed from the SEL 212 through the photonic substrate via the first surface coupler 216 and second surface coupler 214, where second surface coupler 214 both directs the signal light (as emitted signal light) away from the device 204 toward a target 202, and receives the signal light (as reflected signal light) reflected from the target 202. In a second device, the signal light to output from the device 204 is directed from the SEL 212 through the first surface coupler 216 which directs the signal light (as emitted signal light) away from the device 204 toward a target 202, and the second surface coupler 214 receives the signal light (as reflected signal light) reflected from the target 202. In a third device, the signal light (as a first portion of light) to output from the device 204 is emitted from the SEL 212 in a first direction away from the device 204, while the LO light (as a second portion of light) is emitted from the SEL 212 in a second direction (e.g., opposite the first direction) to the photonic substrate via the first surface coupler 216, and the second surface coupler 214 receives the signal light reflected from the target 202.

As further described herein, the first surface coupler 216 may be a grating coupler or a wedge coupler, and the second surface coupler 214 may be a grating coupler or a wedge coupler.

In some embodiments, in addition to photonic elements, components, or structures, the photonic substrate may also include one or more electronic or optoelectronic components, such as integrated electrical conductors, passive components (e.g., resistors, inductors, or capacitors), or active components (e.g., amplifiers, switches, controllers, electrooptical devices, micro electrical mechanical systems, and so on).

Controller 206 (also referred to herein as a control circuit) is coupled with the device 204, or may also be a part of device 204. Controller 206 receives electrical outputs from the set of photodetectors 220, and controls the optical output of SEL 212, for example by controlling a source voltage and/or source current of SEL 212. Controller 206 also provide the modulation signal to the SEL 212, for example the FMCW modulation signal.

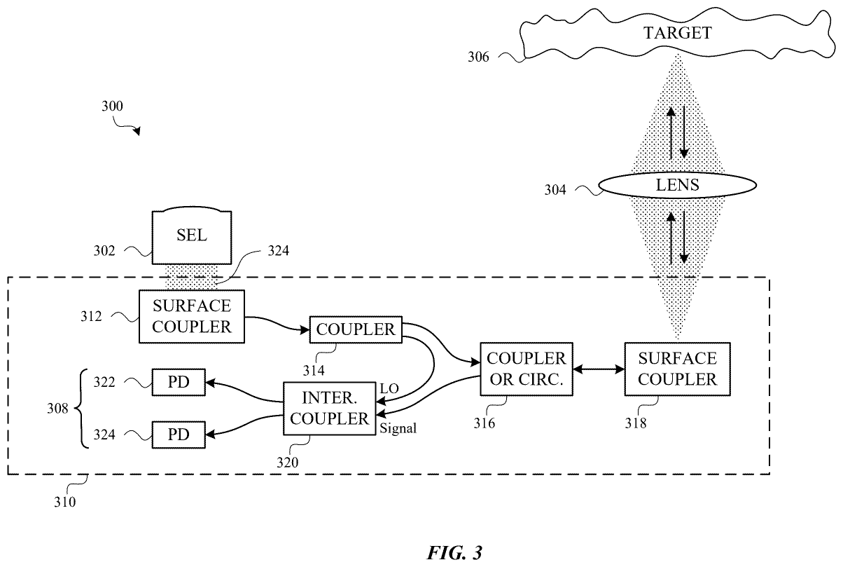

FIG. 3 shows an example device 300, which may be a surface emitting laser-based device for light detection and ranging, according to certain aspects of the present disclosure. Device 300 includes a unit cell 310, which includes a portion of a photonic substrate on which is mounted (affixed, bonded, attached) an SEL 302. The unit cell 310 further includes a set of photodetectors 308. In some embodiments, the photodetectors are integrated (e.g., at least partially embedded) within the photonic substrate of the device 300. In other embodiments, the photodetectors may be mounted on the photonic substrate of device 300. The set of photodetectors 308 includes at least a first photodetector 322 and a second photodetector 324. The photonic substrate includes a first surface coupler 312, a coupler 314 (e.g., a splitter), a coupler or circulator 316, a second surface coupler 318, an interference coupler 320, and optical waveguides coupling these components on or in the photonic substrate of the unit cell 310 as illustrated for device 300. The device 300 may be associated with a lens 304 to focus signal light toward (e.g., as “emitted signal light”) and away from (e.g., as “reflected signal light”) a target 306. In some embodiments, lens 304 may be attached to or coupled with device 300. In other embodiments lens 304 may be external to device 300, or a separate component from device 300. One or more of the SEL 302, the set of photodetectors 308, the first surface coupler 312, the second surface coupler 318, the interference coupler 320, or lens 304 may be examples of one or more of the SEL 212, the set of photodetectors 220, the first surface coupler 216, the second surface coupler 214, the interference coupler 218, or lens 210, respectively, of FIG. 2.

In one or more embodiments the SEL 302 is a vertical cavity SEL (VCSEL), a photonic crystal SEL (PCSEL), or a surface-emitting distributed feedback (DFB) laser. In some embodiments the VCSEL, PCSEL, or surface-emitting DFB laser may be flip-chip bonded to the photonic substrate, and the light emission from the SEL 302 is coupled to a waveguide of the photonic substrate (e.g., a silicon-photonics waveguide) via the first surface coupler 312. In some embodiments, the first surface coupler 312 is a grating coupler. In other embodiments, the first surface coupler 312 is a wedge coupler. The first surface coupler 312 is relatively alignment-insensitive compared to an edge emitting laser (EEL) to waveguide approach.

In general, the photonic substrate includes a substrate layer that serves a base for one or more other layers of the photonic substrate. Additional photonic components, such as the first surface coupler 312, the coupler 314, the coupler or circulator 316, second surface coupler 318, interference coupler 320, and associated waveguides, may be formed using one or more additional layers (e.g., waveguide layers, cladding layers) that are deposited on the substrate layer. In some variations, the photonic substrate may utilize silicon photonic technology, in which the photonic substrate is formed with a silicon substrate layer. In these instances, waveguide may be formed from silicon, silicon nitride, or the like. In one non-limiting example, a silicon photonic substrate may include a silicon substrate layer, a cladding layer (e.g., formed from a cladding material such as silicon dioxide) positioned on the silicon substrate layer, and a waveguide layer (e.g., formed from silicon or silicon nitride) positioned on the cladding layer. The waveguide layer may be patterned to define to define one or more waveguide or other photonic components of the device 300.

In the example of device 300, in some embodiments, a same grating coupler (an example of second surface coupler 318) is used for both transmit and receive, and a single lens 304 can be used, resulting in a simplified optics design. In other embodiments, a vertical edge coupler can replace the grating coupler for second surface coupler 318 for both transmit and receive. In some examples, the second surface coupler 318 is a 45-degree mirror etched in the photonic substrate (e.g., through a waveguide layer of the photonic substrate) to deflect light between horizontal and vertical directions. In some cases, using a 45-degree mirror may improve performance over grating coupler based emitters.

In some cases, the device 300 is relatively less sensitive to laser relative intensity (RIN) noise due to the use of balance photodetection (e.g., first photodetector 322 and second photodetector 324 of the set of photodetectors 308 may be balanced). In some examples the set of photodetectors 308 are waveguide silicon germanium (SiGe) photodetectors.

In one or more embodiments, the LO power split ratio is determined by the design of coupler 314. The power split ratio for device 300 may be selected based on system design requirements.

In some embodiments, the SEL 302 (e.g., a VCSEL) may be one of an array of SELs, each associated with a set of with a parallel silicon-photonics unit cell array can be used to achieve FMCW 3D mapping. The device 300 described herein may be arranged in an array having a relatively tight pitch (e.g., less than about 15 micrometers). An array of grating couplers can also have a tight pitch (e.g., less than about 10 micrometers).

In some embodiments, SEL 302 is an extended cavity VCSEL. In other embodiments, a PCSEL or a surface emitting DFB laser may be used. In some cases, a PCSEL or surface emitting DFB laser can also be a good option for a laser source. One advantage of SEL 302 over an EEL, is that an SEL 302 (e.g., a VCSEL) is less sensitive to back-reflection.

In some embodiments, a wavelength of about 1.31 micrometers is used. In other embodiments, a wavelength of about 1.55 micrometers is used. In still other embodiments, a wavelength of about 1.13 micrometers is used, and such wavelength may provide one or more of the following advantages: (1) being transparent to a silicon waveguide; (2) feasible for gallium arsenide-based VCSELs having good wall plug efficiency (WPE); or (3) 1.13 micrometers is located approximately at the solar ambient light background dip.

In some embodiments, a grating coupler can be fabricated on a VCSEL surface to reach a single polarization. In one or more embodiments, a single polarization can be achieved for a PCSEL via the photonic crystal design.

In some embodiments, a linewidth below a frequency threshold is needed for the FMCW system design. In some embodiments, less than or equal to about 5 MHz linewidth is needed. In some embodiments, for example using a PCSEL for the SEL 302, linewidth of less than about 100 kHz is achievable. In other embodiments, for example using a VCSEL for the SEL 302, an extended cavity within the VCSEL may be needed or used to achieve a linewidth of less than about 5 MHz. In some embodiments, an on-chip lens (OCL) with a top curved dielectric distributed Bragg reflector (DBR) can help achieve the formation of a stable long cavity without diffraction and scatter loss (e.g., substantially without, or with diffraction and/or scatter loss values less than a threshold value) for the VCSEL.

One or both of the first surface coupler 312 or the second surface coupler 318 are designed, or designed for device 300, to have a high efficiency (e.g., an efficiency above an efficiency threshold value), good directionality (e.g., a percentage of light power propagating in a desired direction that is above a power threshold value), low insertion loss (e.g., an insertion loss below an insertion loss threshold value), and/or low back-reflection (e.g., a back-reflection value below a back-reflection threshold value). In one or more embodiments, the first surface coupler 312 is matched to the numerical aperture (NA) of the SEL 302 (e.g., a VCSEL NA), and the second surface coupler 318 is matched to the NA of the required collimated beam size. In some embodiments, the first surface coupler 312 is a grating coupler that is a bi-directional, bi-layer, or single-layer dual polarization grating. In one or more embodiments, the second surface coupler 318 is replaced with a vertical edge coupler. In other embodiments, the second surface coupler 318 is replaced with a regular wedge coupler together with micro-optics (e.g., one or more prisms).

In some embodiments, device 300 may further incorporate a meta-optic element (e.g., a metasurface, diffractive optics, and so) to achieve other optical functionality.

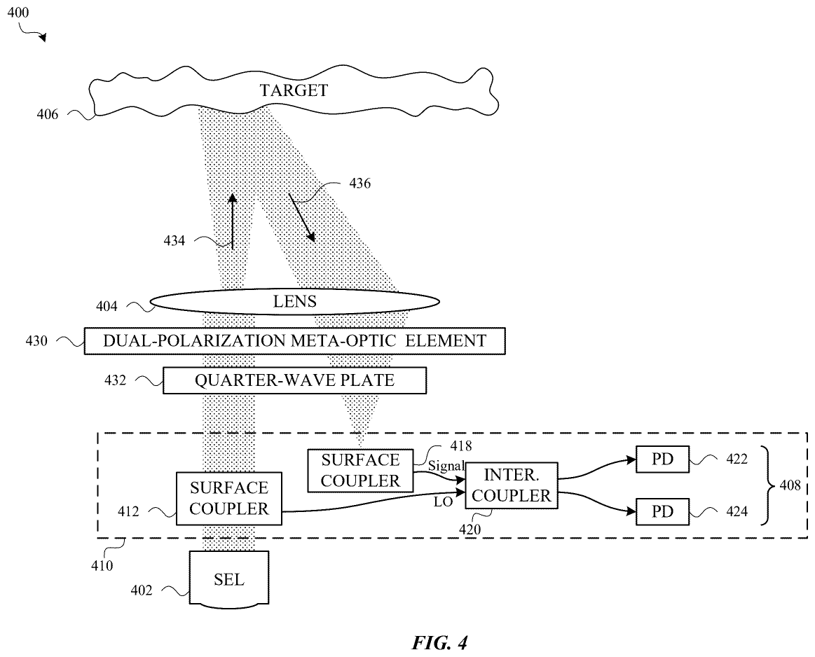

FIG. 4 shows an example device 400, which may be a surface emitting laser-based device for light detection and ranging, according to certain aspects of the present disclosure. Device 400 includes a unit cell 410, which includes a portion of photonic substrate on which is mounted (affixed, bonded, attached) an SEL 402. The unit cell 410 further includes a set of photodetectors 408. In some embodiments, the photodetectors are integrated (e.g., at least partially embedded) within the photonic substrate of the device 400. In other embodiments, the photodetectors may be mounted on the photonic substrate of device 400. The set of photodetectors 408 includes at least a first photodetector 422 and a second photodetector 424. The photonic substrate includes a first surface coupler 412, a second surface coupler 418, an interference coupler 420, and optical waveguides coupling these components on or in the photonic substrate of the unit cell 410 as illustrated for device 400. The device 400 may be associated with a lens 404, dual-polarization meta-optic element 430, and quarter-wave plate 432, to focus and modify an emitted signal light 434 toward a target 406, and focus and modify a reflected signal light 436 returning from the target 406. In some embodiments, one or more of the lens 404, the dual-polarization meta-optic element 430, or the quarter-wave plate 432 may be attached to or otherwise affixed to device 400. In other embodiments the lens 404, dual-polarization meta-optic element 430, or quarter-wave plate 432 may be external to device 400, or a separate component from device 400. One or more of the SEL 402, the set of photodetectors 408, the first surface coupler 412, the second surface coupler 418, the interference coupler 420, or the lens 404 may be examples of one or more of SEL 212, the set of photodetectors 220, the first surface coupler 216, the second surface coupler 214, the interference coupler 218, or lens 210, respectively (or one or more of the SEL 302, the set of photodetectors 308, the first surface coupler 312, the second surface coupler 318, the interference coupler 320, or lens 304, described herein).

In one or more embodiments, device 400 includes a front-emitting SEL 402, which may be a front-emitting VCSEL or PCSEL in some embodiments. The front-emitting SEL 402 may use one surface coupler, the first surface coupler 412, such as a single grating coupler, or single wedge coupler, where the first surface coupler 412 splits the light emitted from SEL 402 into an emitted signal light 434 directed toward the target 406 and a LO light directed toward the interference coupler 420. In one or more embodiments, the SEL 402 uses wavelengths of light as described above with reference to SEL 302.

As illustrated for device 400, the SEL 402 (e.g., a VCSEL or PCSEL) is mounted on a photonic substrate (e.g., a silicon photonic substrate) above the first surface coupler 412 (e.g., a grating coupler or wedge coupler. In some embodiments, SEL 402 has an extended VCSEL cavity formed by a gallium arsenide (GaAs) substrate, with light emission through the photonic substrate. In some embodiments, the first surface coupler 412 is designed such that about 10% of the emitted light that is incident on the first surface coupler 412 is coupled into a waveguide formed in the photonic substrate (e.g., a Si waveguide for a Si substrate layer) as the LO signal. The relative amount of the LO signal that is captured from the incident light can be designed (adjusted, tuned, modified) per requirements to be greater than about 10% or less than about 10% as needed. In some embodiments, the reflected and backward beams can be minimized (e.g., simultaneously kept less than a threshold reflected value and less than a threshold backward value) by the grating coupler design.

In one or more embodiments, the FMCW signal detection for device 400 may be done with silicon photonics (e.g., set of photodetectors 408, and is substantially similar as described elsewhere herein. Similarly, the SEL 402 may be substantially similar.

In some embodiments, for example where a 50:50 grating coupler is used, the first surface coupler 412 and the second surface coupler 418 can be a same physical coupler structure.

In one or more embodiments, the first surface coupler 412 has a different design from the second surface coupler 418. For example, first surface coupler 412 can be matched to the NA of the SEL 402 (e.g., a VCSEL), and second surface coupler 418 can be matched to the NA of an input beam size. In addition, second surface coupler 418 can be a bi-directional, bi-layer or single-layer dual polarization grating.

Lens 404 is used to project the emitted signal light 434 (which may also be referred to as a signal beam) to the far-field (e.g., toward a target 406), as well as to collect the reflected signal light 436 (which may be referred to as reflected light). In order to direct the reflected signal light 436 to a separate surface coupler (e.g., a grating-coupler) such as second surface coupler 418, the quarter-wave plate 432 converts the transmitted signal light to circularly polarized, for example the emitted signal light 434 may be right-hand circularly polarized (RHCP) light. Because the reflected signal light 436 will then be circularly polarized with the opposite handedness (e.g., left-hand circularly polarized (LHCP) for transmitted RHCP light), a dual-polarization meta-optic element 430 creates horizontal focus shift between LHCP and RHCP polarizations. The quarter-wave plate 432 converts the received signal light back to linear polarization.

In other embodiments, the transmitted and received light may used separate lenses. In some embodiments, for the use of separate lenses, the photonics of the photonic substrate (e.g., Si photonics waveguides) and surface couplers (e.g., grating couplers, wedge couplers) span both lenses.

In one or more embodiments, the external optics (e.g., quarter-wave plate 432, dual-polarization meta-optic element 430, and lens 404) are integrated with device 400 at a module level. As further discussed herein, an array of SELs 402 (e.g., array of VCSEL or array of PCSEL) with a grating coupler array can be used to achieve FMCW 3D mapping.

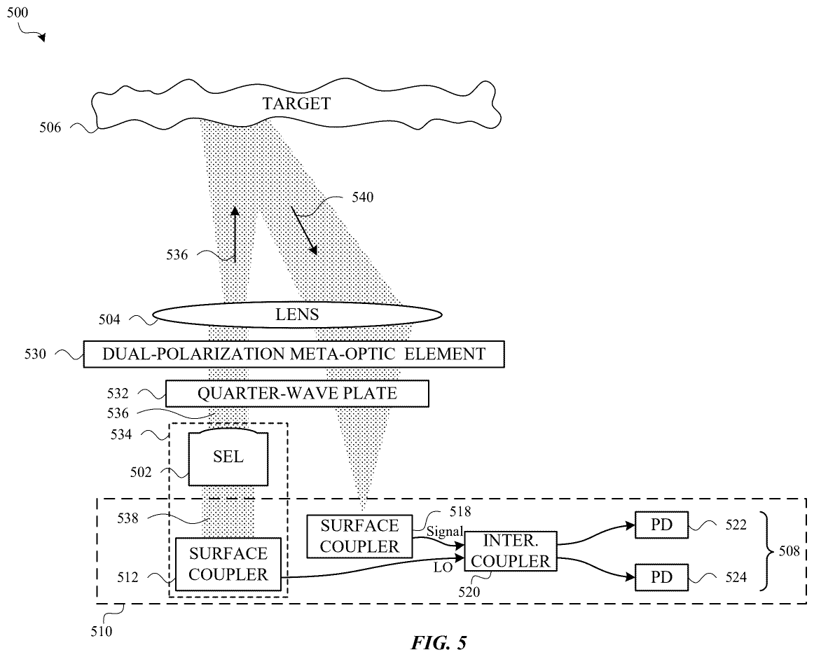

FIG. 5 shows an example device 500, which may be a surface emitting laser-based device for light detection and ranging, according to certain aspects of the present disclosure. Device 500 includes a unit cell 510, which includes a portion of photonic substrate on which is mounted (affixed, bonded, attached) an SEL 502. Unit cell 510 also includes a set of photodetectors 508. In some embodiments, the photodetectors are integrated (e.g., at least partially embedded) within the photonic substrate of the device 500. In other embodiments, the photodetectors may be mounted on the photonic substrate of device 500. The set of photodetectors 508 includes at least a first photodetector 522 and a second photodetector 524. The photonic substrate includes a first surface coupler 512, a second surface coupler 518, an interference coupler 520, and optical waveguides coupling these components on or in the photonic substrate of the unit cell 510 as illustrated for device 500. The device 500 may be associated with a lens 504, dual-polarization meta-optic element 530, and quarter-wave plate 532, to focus and modify an emitted signal light 536 toward a target 506, and focus and modify a reflected signal light 540 returning from the target 506. In some embodiments, one or more of the lens 504, the dual-polarization meta-optic element 530, or the quarter-wave plate 532 may be attached to or otherwise affixed to device 500. In other embodiments the lens 504, dual-polarization meta-optic element 530, or quarter-wave plate 532 may be external to device 500, or a separate component from device 500. One or more of the SEL 502, the set of photodetectors 508, the first surface coupler 512, the second surface coupler 518, the interference coupler 520, or the lens 504 may be examples of one or more of SEL 212, the set of photodetectors 220, the first surface coupler 216, the second surface coupler 214, the interference coupler 218, or lens 210, respectively (or one or more of the SEL 302, the set of photodetectors 308, the first surface coupler 312, the second surface coupler 318, the interference coupler 320, or lens 304, described herein; or one or more of the SEL 402, the set of photodetectors 408, the first surface coupler 412, the second surface coupler 418, the interference coupler 420, or lens 404, described herein).

In one or more embodiments, device 500 includes a dual-emitting SEL 502, with light emission from top and bottom surface simultaneously. SEL502 is a dual-emitting VCSEL or PCSEL in some embodiments, and the photonic substrate a silicon photonic substrate. In one or more embodiments, the VCSEL is an extended-cavity VCSEL (VECSEL), which is dual-emitting.

In one or more embodiments, the SEL 502 (e.g., a VCSEL, PCSEL) is flip-chip bonded to the photonic substrate. The emitted signal light 536 that is emitted through a substrate of SEL 502 is used for target illumination, and reflected signal light 540 functions as signal beam for FMCW. The light emission 538 for the opposite side of the SEL 502 is coupled to a waveguide (e.g., a Si-photonics waveguide) of the photonic substrate via a grating coupler (e.g., the first surface coupler 512) as the LO source. The interference coupler 520, which may be an in-plane coupler in one or more embodiments, combines the return signal beam and LO beam for interference.

In one or more embodiments, the FMCW signal detection for device 400 may be done with silicon photonics (e.g., set of photodetectors 408), and is substantially similar as described elsewhere herein. In one or more embodiments, the set of photodetectors 508 are waveguide SiGe photodetectors that can be used as FMCW signal detection via balanced photodetection.

In one or more embodiments, the SEL 502 uses wavelengths of light, polarization locking, and/or linewidth as described above with reference to SEL 302.

In one or more embodiments, a power split ratio for the emission of light from SEL 502 may be selected to optimize signal to noise ratio (SNR), or otherwise achieve an SNR that exceeds a threshold SNR value. In some embodiments, the power split ratio between signal and LO emissions for SEL 502 is about 9:1.

In one or more embodiments, the second surface coupler 518 is as described herein for second surface coupler 318. In some embodiments, the second surface coupler 518 has an NA of the SEL 502 (e.g., a VCSEL) that is matched to, or matched within, a threshold NA value of an input beam size for a device 100.

In some embodiments, lens 504 is an external lens used to project the emitted signal light 536 to the far-field, as well as to collect the reflected signal light 540. In order to direct the reflected light to a separate grating-coupler, a quarter-wave plate 532 converts the emitted signal light 536 to circularly polarized (e.g., LHCP or RHCP). Since the reflected signal light 540 will then be circularly polarized with the opposite handedness (e.g., RHCP or LHCP, respectively), a dual-polarization meta-optic element 530 creates horizontal focus shift between LHCP and RHCP polarizations. The quarter-wave plate 532 also converts the reflected signal light 540 back to linear polarization.

In other embodiments, the transmit beam and receive beam paths may use separate lenses, and the silicon photonics waveguides and grating couplers (e.g., first surface coupler 512 and second surface coupler 518) span both lenses.

As further discussed herein, an array of SELs 502 (e.g., array of VCSEL or array of PCSEL) with grating coupler array can be scaled and used to achieve FMCW 3D mapping.

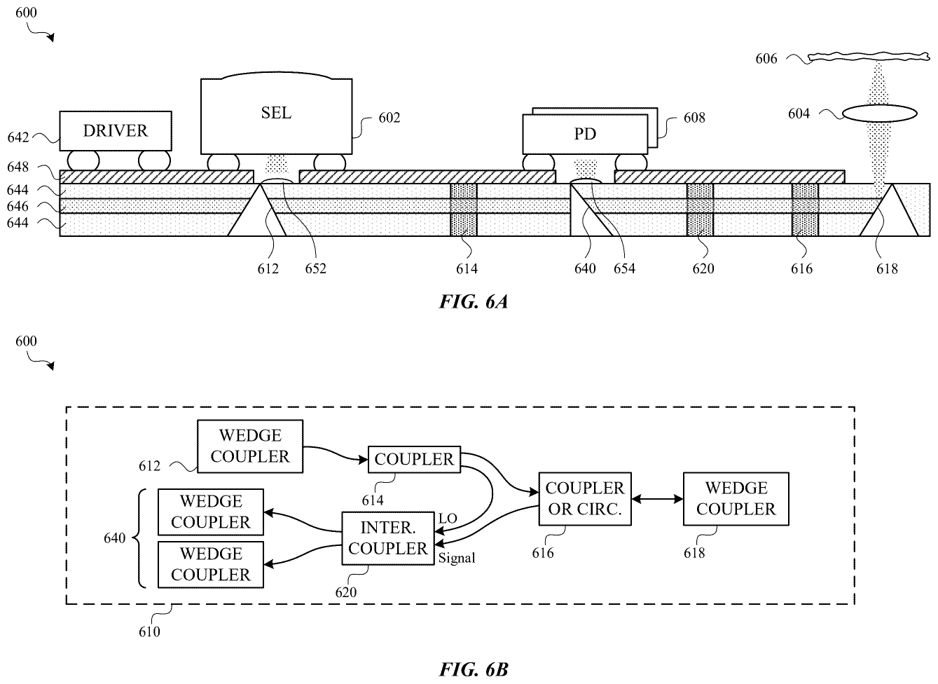

FIGS. 6A and 6B show a side view and a top view, respectively, of an example device 600, which may be a surface emitting laser-based device for light detection and ranging, according to certain aspects of the present disclosure. In one or more embodiments, the device 600 is an example of one or more devices described herein, and includes one or more aspects of device 300, device 400 or device 500. For examples, in some embodiments, SEL 602 may be an example of and include one or more aspects described with reference to one or more of SEL 212, SEL 302, SEL 402, or SEL 502. Coupler 614 may be an example of and include one or more aspects described with reference to coupler 314. Coupler or circulator 616 may be an example of and include one or more aspects described with reference to coupler or circulator 316. Interference coupler 620 may be an example of and include one or more aspects described with reference to interference coupler 320.

In one or more embodiments, the device 600 includes a PCB photonic substrate 644 together with polymer waveguides 646, which may be used for a single-band FMCW solution. Instead of silicon photonics waveguides, SEL 602 (e.g., a VCSEL or PCSEL) may be flip-chip bonded to a surface layer 648 of the PCB photonic substrate 644. Although simplified for clarity, the surface layer 648 may include multiple conductive and non-conductive layers for the distribution and connection of electrical power and signals to various electrical and electrooptical components of the device 600, such as a driver 642 (e.g., an integrated circuit (IC) configured to drive the SEL 602), SEL 602, and set of photodetectors 608.

For device 600, light is coupled into and out of the PCB photonic substrate 644, and the polymer waveguides 646 and various optical components thereof, using wedge couplers, including a first wedge coupler 612, second wedge coupler 618, and a set of photodetector wedge couplers 640. First wedge coupler 612 couples light from SEL 602, into polymer waveguides 646. Second wedge coupler 618 couples signal light out of and into polymer waveguides 646 and toward target 606 via a lens 604.

In one or more embodiments, a first microlens 652 and a second microlens 654 are used for coupling light from SEL 602 and the set of photodetectors 608. The first microlens 652 and the second microlens 654 can be formed on top of the first wedge coupler 612 and photodetector wedge coupler 640, respectively, to change the beam divergence, enhance coupling efficiency, and/or tilt a beam. The tile angle can be different by changing the alignment between the micro-lens and polymer waveguide end.

In some examples, reflow soldering may be used to connect (couple, bond, affix) one or more of the driver 642, SEL 602, and the set of photodetectors 608 to the photonic substrate. In some embodiments, the use of reflow soldering provides good alignment, (e.g., alignment less than an alignment threshold, such as +3 micrometers) to couple light from SEL 602 (e.g., VCSEL light) to the polymer waveguides 646 of the device 600.

A unit cell 610 of waveguide circuitry is illustrated in the top view depicted in FIG. 6B. As discussed herein, including with reference to device 100, a number of unit cells such as an array of unit cell 610 may be used within a LIDAR device.

In one or more embodiments, a driver 642, a set of SELs (a quantity of SEL 602), an array of photodetectors 608, and receiver electronics may be integrated onto a same PCB and form a single board. In some embodiments, the PCB is a flexible PCB. In other embodiments, the PCB is a rigid PCB. Although described with reference to polymers, polymer waveguides 646 can alternatively be glass or other type of material.

In one or more embodiments, SEL 602 may be an extended cavity VCSEL, a PCSEL, or a surface emitting DFB laser. In some embodiments, the set of photodetectors 608 can be selected based on a corresponding wavelength used by SEL 602 (e.g., about 1.1 micrometers or about 1.6 micrometers). In some embodiments, the set of photodetectors 608 are indium gallium arsenide or germanium.

The first wedge coupler 612, the second wedge coupler 618, and the set of photodetector wedge couplers 640 may be designed to have high efficiency (e.g., efficiently above an efficiency threshold), low insertion loss (e.g., insertion loss below an insertion loss threshold), and low transmission loss (e.g., transmission loss below a transmission loss threshold).

In one or more embodiments, first wedge coupler 612 is matched to the NA of the SEL 602, and second wedge coupler 618 is matched to the NA of the required collimated beam size.

In some embodiments, the SEL 602 (e.g., a VCSEL) may be one SEL of an array of SELs associated with a parallel silicon-photonics unit cell array, which can be used to achieve FMCW 3D mapping. The device 600 described herein may be arranged in an array having a relatively tight pitch (e.g., less than about 15 micrometers). An array of grating couplers can also have a tight pitch (e.g., less than about 10 micrometers).

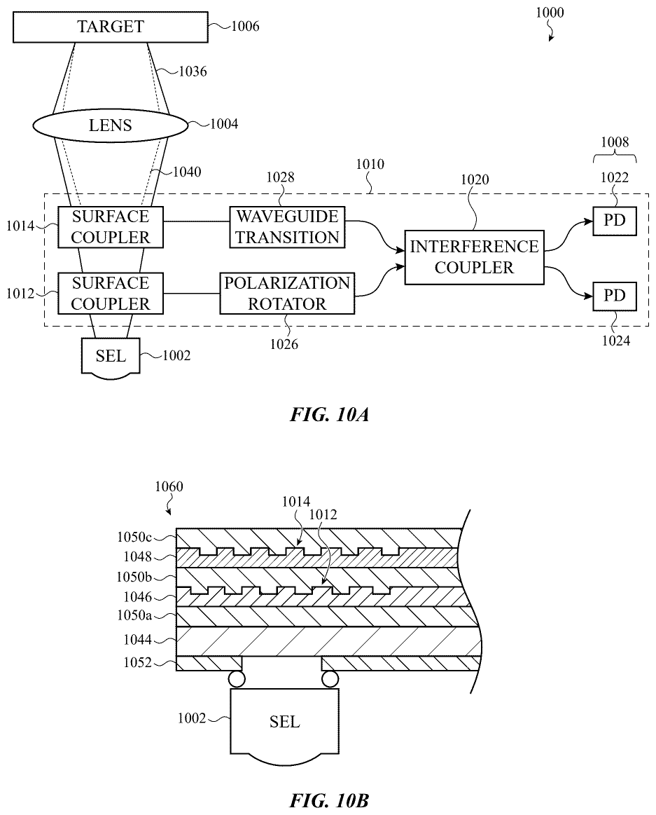

In some variations of the devices described herein, a SEL may be configured to emit light that passes through multiple surface couplers before reaching a target. For example, FIG. 10A shows an example of a device 1000, which may be a surface emitting laser-based device for light detection and ranging, according to certain aspects of the present disclosure. Device 1000 includes a unit cell 1010, which includes a portion of a photonic substrate (e.g., photonic substrate 1060 depicted in FIG. 10B) on which a SEL 1002 is mounted. The unit cell 1010 further includes a set of photonic components formed in the photonic substrate 1060 and a set of photodetectors 1008. The set of photonic components includes a first surface coupler 1012, a second surface coupler 1014, and an interference coupler 1020. The set of photodetectors 1008 includes at least a first photodetector 1022 and a second photodetector 1024, and the set of photodetectors 1008 may be integrated within or mounted on the photonic substrate 1060 in any manner as described herein.

The interference coupler 1020, which may be a multi-mode interference (MMI) coupler, a Mach-Zehnder interferometer (MZI), or the like, may be configured to interfere light received by the first surface coupler 1012 and the second surface coupler 1014. For example, the interference coupler 1020 may include a first input that is configured to received light from the first surface coupler 1012 and a second input that is configured to receive light from the second surface coupler 1014. The interference coupler 1020 may generate two optical outputs based on the interference of light within the interference coupler 1020, and the set of photodetectors 1008 may measure these optical outputs. For example, the first photodetector 1022 may receive a first optical output from a first output of the interference coupler 1020 and the second photodetector 1024 may receive a second optical output from a second output of the interference coupler 1020. In instances where the first photodetector 1022 and the second photodetector 1024 are balanced photodetectors, the set of photodetectors 1008 may output a single signal (e.g., via an amplifier connected to the first photodetector 1022 and the second photodetector 1024) that represents a difference between the first and second optical output. The output of the set of photodetectors 1008 may be used in any of the mapping and object detection operations as described herein. It should be appreciated that the device 1000 may include a plurality of unit cells, where each unit cell includes a respective SEL and is configured as described herein with respect to unit cell 1010.

In the variation of the device 1000 shown in FIGS. 10A and 10B, the SEL 1002 is positioned to emit light toward the photonic substrate 1060. Specifically, the SEL 1002 is positioned such that a portion of the light emitted by the SEL 1002 passes through the photonic substrate 1060 as emitted signal light 1036 that is directed toward a target 1006. The first surface coupler 1012 and the second surface coupler 1014 are positioned such that the emitted signal light 1036 passes through each of the first surface coupler 1012 and the second surface coupler 1014 before exiting the photonic substrate 1060.

Specifically, the first surface coupler 1012 and the second surface coupler 1014 are formed in different layers of the photonic substrate 1060 such that the first surface coupler 1012 is positioned between the second surface coupler 1014 and the SEL 1002. For example, FIG. 10B shows one such example of a photonic substrate 1060 in which the first surface coupler 1012 and the second surface coupler 1014 are formed in different waveguide layers of the photonic substrate 1060. Specifically, the photonic substrate 1060 may include a substrate layer 1044 (e.g., formed from silicon), and a plurality of layers supported by the substrate layer 1044 that includes at least a first waveguide layer 1046 and a second waveguide layer 1048, where the first waveguide layer 1046 is positioned between the substrate layer 1004 and the second waveguide layer 1048. In some instances, the first surface coupler 1012 is a first grating coupler formed in the first waveguide layer 1046. In these instances, a portion of the first waveguide layer 1046 may be patterned or otherwise formed to define the first grating coupler. Similarly, the second surface coupler 1014 may be a second grating coupler formed in the second waveguide layer 1048, and a portion of the second waveguide layer 1048 may be patterned or otherwise formed to define the second grating coupler.

In some variations, the first waveguide layer 1046 and the second waveguide layer 1048 are formed from a common material (e.g., silicon or silicon nitride). In other variations, the first waveguide layer 1046 and the second waveguide layer 1048 are formed from different materials. For example, in the variation of the photonic substrate 1060 shown in FIG. 10B, the first waveguide layer 1046 is formed form a different material than the second waveguide layer 1048. In some of these variations, the first waveguide layer 1046 is formed from silicon and the second waveguide layer 1048 is formed from silicon nitride. In these instances, the first surface coupler 1012 may be formed from silicon and the second surface coupler 1014 may be formed from silicon nitride.

The plurality of layers supported by the substrate layer 1044 may also include a set of cladding layers 1050a-1050c, each of which may be formed from a cladding material such as silicon dioxide. For example, in the variation shown in FIG. 10B, the set of cladding layers 1050a-1050c includes a first cladding layer 1050a positioned between the first waveguide layer 1046 and the substrate layer 1044, a second cladding layer 1050b positioned between the first waveguide layer 1046 and the second waveguide layer 1048, and a third cladding layer 1050c positioned above the second waveguide layer 1048. Accordingly, the first waveguide layer 1046 may be positioned between the first cladding layer 1050a and the second cladding layer 1050b, and the second waveguide layer 1048 may be positioned between the second cladding layer 1050b and the third cladding layer 1050c.

In some variations, the photonic substrate 1060 may include a set of surface layers (depicted in FIG. 10B as a single layer 1052), which in the variation of FIG. 10B are positioned on the substrate layer 1044. Various components of the device 1000 may be mounted to the photonic substrate 1060 by the set of surface layers 1052. The set of surface layers 1052 may include conductive and non-conductive layers to facilitate electrical connection of components of the device 1000, such as described herein. For example, the SEL 1002 is shown in FIG. 10B as mounted to the set of surface layers 1052. In these variations the set of surface layers 1052 may be configured to electrically connect the SEL 1002 to a driver (such as driver 642) that is configured to operate the SEL 1002 to emit light. Similarly, one or more photodetectors of the set of photodetectors 1008 may be mounted to the surface layers 1052.

The first surface coupler 1012 and the second surface coupler 1014 are configured to be sensitive to different polarization of light. Specifically, the first surface coupler 1012 may be configured to couple light of a first polarization into a first waveguide of the photonic substrate (e.g., a first waveguide formed in the first waveguide layer 1046) and to pass light having a second polarization orthogonal to the first polarization. Conversely, the second surface coupler 1012 may be configured to couple light of the second polarization into a second waveguide of the photonic substrate (e.g., a second waveguide formed in the second waveguide layer 1048) and to pass light having the first polarization. In some variations, the first polarization is a TM polarization, and the second polarization is a TE polarization.

The SEL 1002 is configured to emit polarized light having the first polarization (e.g., TM polarization). The first surface coupler 1012 is configured such that, when the polarized light emitted by the SEL 1002 is incident on the first surface coupler 1012, a portion of the incident polarized light is coupled into the first waveguide. This light may be routed to the interference coupler 1020 as a LO light, such as described herein. The first surface coupler 1012 may be configured such that a predetermined percentage of incident polarized light (e.g., having the first polarization) emitted by the SEL 1002 will couple into the first waveguide. In one non-limiting example, the first surface coupler 1012 may be configured such that 10% of incident light having the first polarization will be coupled into the first waveguide by the first surface coupler 1012.

The remaining polarized light emitted by the SEL 1002 may pass through the first surface coupler 1012 and may be incident on the second surface coupler 1014. In this way, the polarized light emitted by the SEL 1002 may include a first portion (e.g., the LO portion) that is captured by first surface coupler 1012 and a second portion that is passed through the first surface coupler 1012. Because the second surface coupler 1014 is configured to pass light having the first polarization, this light may pass through the second surface coupler 1014 and may exit the photonic substrate 1060 as emitted signal light 1036. The device may be configured to direct the emitted signal light 1036 to the target 1006. For example, the device 1000 may include a lens 1004 that is configured to direct the emitted signal light 1036 to the target 1006, such as described in more detail herein.

A portion of the emitted signal light 1036 may be returned form the target 1006 as reflected signal light 1040. For example, the lens 1004 may be configured to direct the reflected signal light 1040 to the photonic substrate 1060, such that the reflected signal light 1040 is incident on the second surface coupler 1014. Whereas the emitted signal light 1036 may be polarized with the first polarization, the reflected signal light 1040 may be at least partially depolarized (e.g., may include light of both the first polarization and the second polarization) due to interaction with the target 1006. Accordingly, when the reflected signal light 1040 is incident on the second surface coupler 1014, a portion of reflected signal light 1040 having the second polarization will be coupled into the second waveguide. This light may be routed to the interference coupler 1020 as collected signal light, where it will be interfered with the LO light as discussed in more detail herein. The second surface coupler 1014 may be configured such that a predetermined percentage of incident light having the second polarization (e.g., from the reflected signal light 1040) will be coupled into the second waveguide. In one non-limiting example, the second surface coupler 1014 may be configured such that 80% of the incident light having the second polarization will be coupled into the second waveguide by the second surface coupler 1014.

The portion of the reflected signal light 1040 that is polarized with the first polarization direction may pass through the second surface coupler 1014 and may be incident on the first surface coupler 1012. Accordingly, some of this light may also couple into first waveguide via the first surface coupler 1012. The intensity of this reflected signal light 1040 having the first polarization may be significantly less than the polarization of light emitted by the SEL 1002, and thus this additional light coupled into the first waveguide by the first surface coupler 1012 may not meaningfully impact the operation of the device 1000.

In some variations, it may be desirable for the interference coupler 1020 to interfere light having a common polarization. Accordingly, the device 1000 may be configured to convert the collected signal light and the LO light to a common polarization before it reaches the interference coupler, such that the LO light and the collected signal light have the common polarization when interfered by the interference coupler 1020. For example, the unit cell 1010 of the device 1000 may include a polarization rotator 1026 that is configured to change the polarization of light collected by the first surface coupler 1012 or the second surface coupler 1014. In the variation shown in FIG. 10A, the polarization rotator 1026 is configured to convert light of the first polarization collected by the first surface coupler 1012 (e.g., as carried by the first waveguide) from the first polarization to the second polarization. In these instances, although the LO light initially has the first polarization (e.g., TM polarization) when captured by the first surface coupler 1012, the LO light will have the second polarization (e.g., TE polarization) when it reaches the interference coupler 1020, such that both the LO light and the collected signal light have the second polarization when interfered by the interference coupler 1020. In other variations, the polarization rotator 1026 is configured to convert the collected signal light captured by the second surface coupler 1014 from the second polarization to the first polarization. In these variations, the LO light and the collected signal light will each have the first polarization when interfered by the interference coupler 1020.

Because the first surface coupler 1012 and the second surface coupler 1014 are formed in different layers of the photonic substrate 1060, it may be desirable to route the LO light and the collected signal light to a common waveguide layer before it reaches the interference coupler. For example, in the variation shown in FIG. 10A, the unit cell 1010 of the device 1000 includes a waveguide transition 1028 that is configured to transfer light from the second waveguide layer 1048 to the first waveguide layer 1046. Accordingly, the collected signal light may be captured by the second surface coupler 1014 in the second waveguide layer 1048, and may be transferred to the first waveguide layer 1046 before it reaches the interference coupler 1020. In these variations, the interference coupler 1020 may be formed in the first waveguide layer 1046. In other variations, the interference coupler 1020 may be formed in the second waveguide layer 1048, and the waveguide transition 1028 may be configured to route LO light from the first waveguide layer 1046 to the second waveguide layer 1048. It should be appreciated that the waveguide transition 1028 may utilize any vertical coupling techniques (e.g., grating couplers, tapered waveguides, or the like) as may be needed to transition light between different waveguide layers of the photonic substrate 1060.

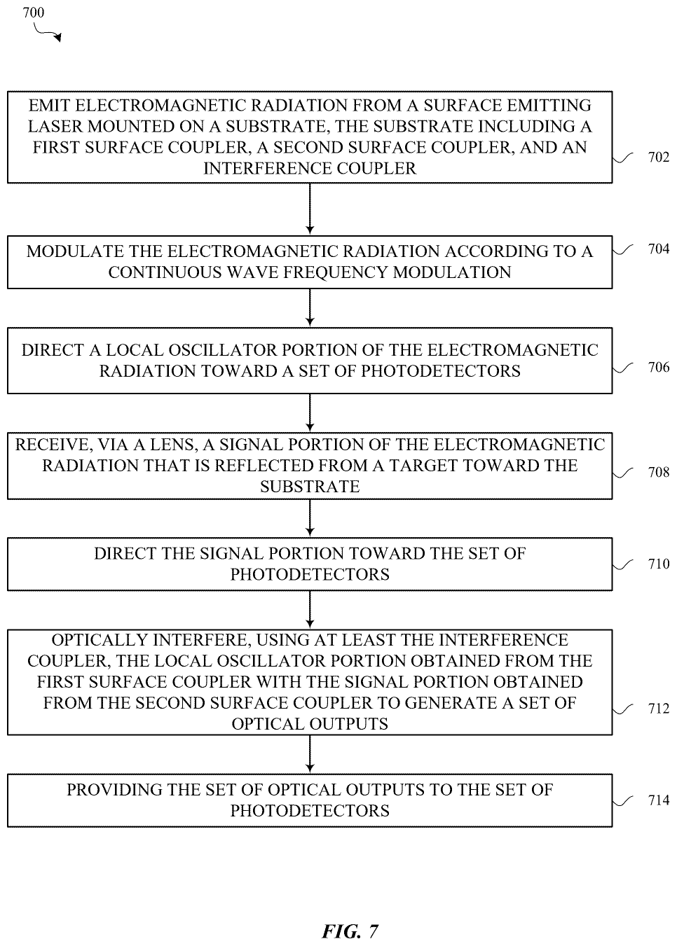

FIG. 7 shows an example method 700, according to one or more aspects described herein. In one or more embodiments, method 700 supports one or more aspects of a surface emitting laser-based device for light detection and ranging, as further described herein. In one or more embodiments, method 700 may be performed in whole or in part by a device 100, device 200, device 300, device 400, device 500, device 600, electronic device 900, or one of the other devices described herein. The method 700 may be performed using a processor (e.g., a processor 904), the sensor system 910, or other components of the device.

At 702, the method 700 includes emitting electromagnetic radiation from a surface emitting laser mounted on a photonic substrate, the photonic substrate including a first surface coupler, a second surface coupler, and an interference coupler.

At 704, the method 700 includes modulating the electromagnetic radiation according to a continuous wave frequency modulation.

At 706, the method 700 includes directing a local oscillator portion of the electromagnetic radiation toward a set of photodetectors.

At 708, the method 700 includes receiving, via a lens, a signal portion of the electromagnetic radiation that is reflected from a target toward the photonic substrate.

At 710, the method 700 includes directing the signal portion toward the set of photodetectors.

At 712, the method 700 includes optically interfering, using at least the interference coupler, the local oscillator portion obtained from the first surface coupler with the signal portion obtained from the second surface coupler to generate a set of optical outputs.

At 714, the method 700 includes providing the set of optical outputs to the set of photodetectors.

In one or more embodiments, the method further includes directing, using the second surface coupler, the electromagnetic radiation from the surface emitting laser away from the photonic substrate via the lens for reflection from the target.

In one or more embodiments, the method further includes directing, using the first surface coupler, the electromagnetic radiation from the surface emitting laser away from the photonic substrate via the lens for reflection from the target.

In one or more embodiments, the method further includes emitting the electromagnetic radiation toward the first surface coupler of the photonic substrate and away from the photonic substrate via the lens for reflection from the target.

In one or more embodiments, the method further includes emitting, sequentially via a quarter-wave plate, a dual polarization meta optic element, and the lens, the signal portion of the electromagnetic radiation from the surface emitting laser. The method further includes receiving, sequentially via the lens, the dual polarization meta optic element, and the quarter-wave plate, the signal portion of the electromagnetic radiation that is reflected from the target.

In some embodiments, at least one of the first surface coupler or the second surface coupler is a grating coupler. In some embodiments, at least one of the first surface coupler or the second surface coupler is a wedge coupler.

In some embodiments, the photonic substrate further includes at least one of a first micro-lens disposed on the photonic substrate between the first surface coupler and the surface emitting laser, or a second micro-lens disposed on the photonic substrate between the second surface coupler and at least one photodetector of the set of photodetectors.

In some embodiments, the surface emitting laser includes a single-emitting vertical cavity surface emitting laser, a dual-emitting vertical cavity surface emitting laser, a photonic crystal surface emitting laser, or a surface emitting distributed feedback laser.

In some embodiments, the photonic substrate includes a silicon substrate layer, a first one or more silicon waveguides formed on the silicon substrate layer between the first surface coupler and the interference coupler, and a second one or more silicon waveguides formed in the silicon substrate layer between the second surface coupler and the interference coupler.

In some embodiments, the photonic substrate includes a printed circuit board, a first one or more polymer waveguides formed in the printed circuit board between the first surface coupler and the interference coupler, and a second one or more polymer waveguides formed in the printed circuit board between the second surface coupler and the interference coupler.

The method 700 may be variously embodied, extended, or adapted, as described in the following paragraphs and elsewhere in this description.

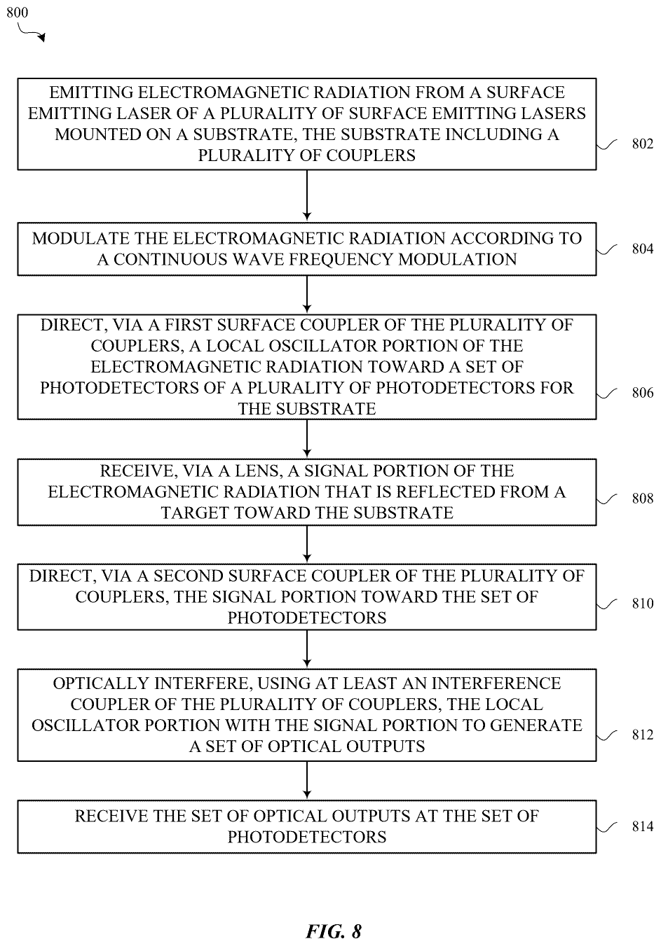

FIG. 8 shows an example method 800 according to one or more aspects described herein. In one or more embodiments, method 800 supports one or more aspects of a surface emitting laser-based device for light detection and ranging, as further described herein. In one or more embodiments, method 800 may be performed in whole or in part by a device 100, device 200, device 300, device 400, device 500, device 600, electronic device 900, or one of the other devices described herein. The method 800 may be performed using a processor (e.g., a processor 904), the sensor system 910, or other components of the device.

At 802, the method 800 includes emitting electromagnetic radiation from a surface emitting laser of a plurality of surface emitting lasers mounted on a photonic substrate, the photonic substrate including a plurality a plurality of couplers.

At 804, the method 800 includes modulating the electromagnetic radiation according to a continuous wave frequency modulation.

At 806, the method 800 includes directing, via a first surface coupler of the plurality of couplers, a local oscillator portion of the electromagnetic radiation toward a set of photodetectors of a plurality of photodetectors for the photonic substrate.

At 808, the method 800 includes receiving, via a lens, a signal portion of the electromagnetic radiation that is reflected from a target toward the photonic substrate.

At 810, the method 800 includes directing, via a second surface coupler of the plurality of couplers, the signal portion toward the set of photodetectors.

At 812, the method 800 includes optically interfering, using at least an interference coupler of the plurality of couplers, the local oscillator portion with the signal portion to generate a set of optical outputs.

At 814, the method 800 includes receiving the optical outputs at the set of photodetectors.

In one or more embodiments, the method further includes directing, using the second surface coupler, the electromagnetic radiation from the surface emitting laser away from the photonic substrate via the lens for reflection from the target.

In one or more embodiments, the method further includes directing, using the first surface coupler, the electromagnetic radiation from the surface emitting laser away from the photonic substrate via the lens for reflection from the target.

In one or more embodiments, the method further includes emitting the electromagnetic radiation toward the first surface coupler of the photonic substrate and away from the photonic substrate via the lens for reflection from the target.

In one or more embodiments, the method further includes emitting, sequentially via a quarter-wave plate, a dual polarization meta optic element, and the lens, the signal portion of the electromagnetic radiation from the surface emitting laser. The method further includes receiving, sequentially via the lens, the dual polarization meta optic element, and the quarter-wave plate, the signal portion of the electromagnetic radiation that is reflected from the target.

In some embodiments, at least one of the first surface coupler or the second surface coupler is a grating coupler. In some embodiments, at least one of the first surface coupler or the second surface coupler is a wedge coupler.

In some embodiments, the photonic substrate further includes at least one of a first micro-lens disposed on the photonic substrate between the first surface coupler and the surface emitting laser, or a second micro-lens disposed on the photonic substrate between the second surface coupler and at least one photodetector of the set of photodetectors.

In some embodiments, the surface emitting laser includes a single-emitting vertical cavity surface emitting laser, a dual-emitting vertical cavity surface emitting laser, a photonic crystal surface emitting laser, or a surface emitting distributed feedback laser.

In some embodiments, the photonic substrate includes a silicon substrate layer, a first one or more silicon waveguides formed in the silicon substrate layer between the first surface coupler and the interference coupler, and a second one or more silicon waveguides formed in the silicon substrate layer between the second surface coupler and the interference coupler.

In some embodiments, the photonic substrate includes a printed circuit board, a first one or more polymer waveguides formed in the printed circuit board between the first surface coupler and the interference coupler, and a second one or more polymer waveguides formed in the printed circuit board between the second surface coupler and the interference coupler.

The method 800 may be variously embodied, extended, or adapted, as described in the following paragraphs and elsewhere in this description.

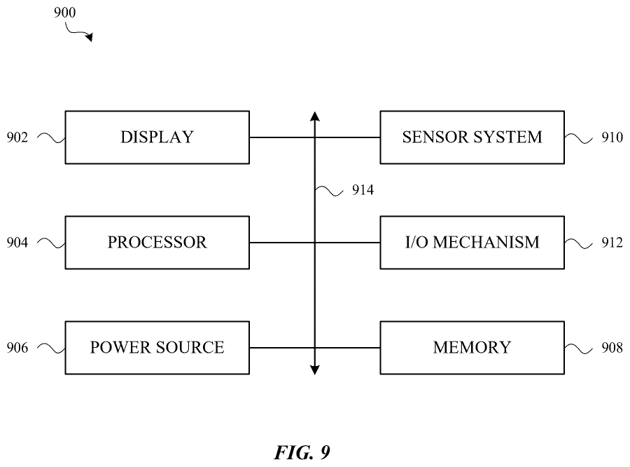

FIG. 9 shows an example electrical block diagram of an electronic device 900 having a light detection and ranging device, such as one of the surface emitting laser-based devices for light detection and ranging described herein, including systems for light detection and ranging incorporating such devices. The electronic device 900 may take forms such as a hand-held or portable device (e.g., a smartphone, tablet computer, or electronic watch), a navigation system of a vehicle, and so on. The electronic device 900 may include an optional display 902 (e.g., a light-emitting display), a processor 904, a power source 906, a memory 908 or storage device, a sensor system 910, and an optional input/output (I/O) mechanism 912 (e.g., an input/output device and/or input/output port). The processor 904 may control some or all of the operations of the electronic device 900. The processor 904 may communicate, either directly or indirectly, with substantially all of the components of the electronic device 900. For example, a system bus or other communication mechanism 914 may provide communication between the processor 904, the power source 906, the memory 908, the sensor system 910, and/or the I/O mechanism 912.

The processor 904 may be implemented as any electronic device capable of processing, receiving, or transmitting data or instructions. For example, the processor 904 may be a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

In some embodiments, the components of the electronic device 900 may be controlled by multiple processors. For example, select components of the electronic device 900 may be controlled by a first processor and other components of the electronic device 900 may be controlled by a second processor, where the first and second processors may or may not be in communication with each other.

The power source 906 may be implemented with any device capable of providing energy to the electronic device 900. For example, the power source 906 may include one or more disposable or rechargeable batteries. Additionally, or alternatively, the power source 906 may include a power connector or power cord that connects the electronic device 900 to another power source, such as a wall outlet, or a wireless charging circuit.

The memory 908 may store electronic data that may be used by the electronic device 900. For example, the memory 908 may store electrical data or content such as, for example, audio and video files, documents and applications, device settings and user preferences, timing signals, control signals, data structures or databases, image data, maps, or focus settings. The memory 908 may be configured as any type of memory. By way of example only, the memory 908 may be implemented as random access memory, read-only memory, Flash memory, removable memory, other types of storage elements, or combinations of such devices.

The electronic device 900 may also include one or more sensors defining the sensor system 910. The sensors may be positioned substantially anywhere on the electronic device 900. The sensor(s) may be configured to sense substantially any type of characteristic, such as but not limited to, touch, force, pressure, electromagnetic radiation (e.g., light), heat, movement, relative motion, biometric data, distance, and so on. For example, the sensor system 910 may include a touch sensor, a force sensor, a heat sensor, a position sensor, a light or optical sensor, an accelerometer, a pressure sensor (e.g., a pressure transducer), a gyroscope, a magnetometer, a health monitoring sensor, an image sensor, and so on. Additionally, the one or more sensors may utilize any suitable sensing technology, including, but not limited to, capacitive, ultrasonic, resistive, optical, ultrasound, piezoelectric, and thermal sensing technology.

In one or more embodiments, the sensor system 910 includes an SEL-based device for light detection and ranging. In some embodiments, the device includes a lens, a photonic substrate, a surface emitting laser mounted on the photonic substrate, and a set of photodetectors. The photonic substrate includes a first surface coupler, a second surface coupler, and an interference coupler. The surface emitting laser emits electromagnetic radiation that is modulated according to a continuous wave frequency modulation. The first surface coupler directs a local oscillator portion of the electromagnetic radiation toward the set of photodetectors. The second surface coupler directs, toward the set of photodetectors, a signal portion of the electromagnetic radiation that is reflected from a target and received via the lens. The interference coupler optically interferes the local oscillator portion of the electromagnetic radiation from the first surface coupler with the signal portion of the electromagnetic radiation from the second surface coupler to generate a set of optical outputs that are provided to the set of photodetectors.

In some embodiments, the device includes an array of unit cells and a lens to direct a signal portion of electromagnetic radiation reflected from a target. Each unit cell of the array of unit cells includes a surface emitting laser, a set of photodetectors, a first surface coupler, a second surface coupler, and an interference coupler. The surface emitting laser is mounted on a portion of a photonic substrate. The surface emitting laser emits electromagnetic radiation that is modulated according to a continuous wave frequency modulation. The set of photodetectors are also for the portion of the photonic substrate with the surface emitting laser. The first surface coupler is formed in the portion of the photonic substrate, and directs a local oscillator portion of the electromagnetic radiation from the surface emitting laser toward the set of photodetectors. The second surface coupler is formed in the portion of the photonic substrate, and directs the signal portion of the electromagnetic radiation reflected from the target toward the set of photodetectors. The interference coupler is also formed in the portion of the photonic substrate with the first and second surface couplers, and optically interferes the local oscillator portion of the electromagnetic radiation with the signal portion of the electromagnetic radiation to generate a set of optical outputs to provide to the set of photodetectors.

In some embodiments, the sensor system 910 (e.g., the above discussed device of the sensor system 910) performs emitting electromagnetic radiation from a surface emitting laser mounted on a photonic substrate, the photonic substrate including a first surface coupler, a second surface coupler, and an interference coupler; modulating the electromagnetic radiation according to a continuous wave frequency modulation; directing a local oscillator portion of the electromagnetic radiation toward a set of photodetectors; receiving, via a lens, a signal portion of the electromagnetic radiation that is reflected from a target toward the photonic substrate; directing the signal portion toward the set of photodetectors; optically interfering, using at least the interference coupler, the local oscillator portion obtained from the first surface coupler with the signal portion obtained from the second surface coupler to generate a set of optical outputs; providing the set of optical outputs to the set of photodetectors.

The I/O mechanism 912 may transmit and/or receive data to/from a user or another electronic device. An I/O device may include a display, a touch sensing input surface such as a track pad, one or more buttons (e.g., a graphical user interface “home” button, one of the buttons described herein, or a crown), one or more cameras (including one or more image sensors), one or more microphones or speakers, one or more ports such as a microphone port, and/or a keyboard. Additionally, or alternatively, an I/O device or port may transmit electronic signals via a communications network, such as a wireless and/or wired network connection. Examples of wireless and wired network connections include, but are not limited to, cellular, Wi-Fi, Bluetooth, IR, and Ethernet connections. The I/O mechanism 912 may also provide feedback (e.g., a haptic output) to a user.

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively.

Additionally, directional terminology, such as “top”, “bottom”, “upper”, “lower”, “front”, “back”, “over”, “under”, “above”, “below”, “left”, “right”, etc. is used with reference to the orientation of some of the components in some of the figures described herein. Because components in various embodiments can be positioned in a number of different orientations, directional terminology is used for purposes of illustration only and is in no way limiting. The directional terminology is intended to be construed broadly, and therefore should not be interpreted to preclude components being oriented in different ways. These words are intended to relate to the equivalent direction as depicted in a reference illustration; as understood contextually from the object(s) or element(s) being referenced, such as from a commonly used position for the object(s) or element(s); or as otherwise described herein. Further, it is noted that the term “signal” means a waveform (e.g., electrical, optical, magnetic, mechanical, or electromagnetic) capable of traveling through a medium such as DC, AC, sinusoidal-wave, triangular-wave, square-wave, vibration, and the like.

Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

Although the disclosed embodiments have been illustrated and described with respect to one or more implementations, equivalent alterations and modifications will occur or be known to others skilled in the art upon the reading and understanding of this specification and the annexed drawings. In addition, while a particular feature is disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and are not limiting. Numerous changes to the disclosed embodiments can be made in accordance with the disclosure herein, without departing from the spirit or scope of the disclosure. Thus, the breadth and scope of the present disclosure should not be limited by any of the above-described embodiments. Rather, the scope of the disclosure should be defined in accordance with the following claims and their equivalents.

1. A device, comprising:
a lens;
a photonic substrate comprising a first surface coupler, a second surface coupler, and an interference coupler;
a surface emitting laser mounted on the photonic substrate, the surface emitting laser to emit electromagnetic radiation that is modulated according to a continuous wave frequency modulation; and
a set of photodetectors, wherein:
the first surface coupler directs a local oscillator portion of the electromagnetic radiation toward the set of photodetectors;
the second surface coupler directs, toward the set of photodetectors, a signal portion of the electromagnetic radiation that is reflected from a target and received via the lens; and
the interference coupler optically interferes the local oscillator portion of the electromagnetic radiation from the first surface coupler with the signal portion of the electromagnetic radiation from the second surface coupler to generate a set of optical outputs that are provided to the set of photodetectors.

2. The device of claim 1, wherein the second surface coupler further directs the electromagnetic radiation from the surface emitting laser away from the device via the lens for reflection from the target.

3. The device of claim 1, wherein the first surface coupler further directs the electromagnetic radiation from the surface emitting laser away from the device via the lens for reflection from the target.

4. The device of claim 1, wherein the surface emitting laser is configured to emit the electromagnetic radiation toward the first surface coupler of the photonic substrate and away from the device via the lens for reflection from the target.

5. The device of claim 1, further comprising:
a dual polarization meta optic element; and
a quarter-wave plate, wherein the signal portion of the electromagnetic radiation that is reflected from the target is sequentially received at the second surface coupler via the lens, the dual polarization meta optic element, and the quarter-wave plate, and wherein the electromagnetic radiation is emitted from the surface emitting laser away from the device for reflection from the target sequentially via the quarter-wave plate, the dual polarization meta optic element, and the lens.

6. The device of claim 1, wherein at least one of the first surface coupler or the second surface coupler is a grating coupler.

7. The device of claim 1, wherein at least one of the first surface coupler or the second surface coupler is a wedge coupler.

8. The device of claim 7, wherein the photonic substrate further comprises at least one of:
a first micro-lens disposed on the photonic substrate between the first surface coupler and the surface emitting laser; or
a second micro-lens disposed on the photonic substrate between the second surface coupler and at least one photodetector of the set of photodetectors.

9. The device of claim 1, wherein the surface emitting laser comprises a single-emitting vertical cavity surface emitting laser, a dual-emitting vertical cavity surface emitting laser, a photonic crystal surface emitting laser, or a surface emitting distributed feedback laser.

10. The device of claim 1, wherein the photonic substrate comprises:
a silicon substrate layer;
a first one or more waveguides formed on the silicon substrate layer between the first surface coupler and the interference coupler, wherein the first one or more waveguides comprise silicon waveguides or silicon nitride waveguides; and
a second one or more waveguides formed one the silicon substrate layer between the second surface coupler and the interference coupler, wherein the second one or more waveguides comprise silicon waveguides or silicon nitride waveguides.

11. The device of claim 1, wherein the photonic substrate comprises:
a printed circuit board;
a first one or more polymer waveguides formed in the printed circuit board between the first surface coupler and the interference coupler; and
a second one or more polymer waveguides formed in the printed circuit board between the second surface coupler and the interference coupler.

12. A device, comprising:
a photonic substrate including a plurality of couplers;
a plurality of photodetectors mounted on the photonic substrate;
a plurality of surface emitting lasers mounted to the photonic substrate to emit electromagnetic radiation that is modulated according to a continuous wave frequency modulation; and
a lens coupled to the photonic substrate and configured to direct a signal portion of the electromagnetic radiation reflected from a target toward the photonic substrate,
wherein the photonic substrate is configured, for each surface emitting laser of the plurality of surface emitting lasers, to,
direct, via a first surface coupler of the plurality of couplers, a local oscillator portion of the electromagnetic radiation from the surface emitting laser toward a set of photodetectors of the plurality of photodetectors;
direct, via a second surface coupler of the plurality of couplers, the signal portion of the electromagnetic radiation toward the set of photodetectors; and
optically interfere, at an interference coupler of the plurality of couplers, the local oscillator portion of the electromagnetic radiation with the signal portion of the electromagnetic radiation to generate a set of optical outputs that are received at the set of photodetectors.

13. The device of claim 12, wherein the second surface coupler further directs the signal portion of the electromagnetic radiation from the surface emitting laser away from the device via the lens for reflection from the target.

14. The device of claim 12, wherein the first surface coupler further directs the signal portion of the electromagnetic radiation from the surface emitting laser away from the device via the lens for reflection from the target.

15. The device of claim 12, wherein each surface emitting laser of the plurality of surface emitting lasers is configured to emit the local oscillator portion of the electromagnetic radiation toward the first surface coupler of the photonic substrate, and emit the signal portion of the electromagnetic radiation away from the device via the lens for reflection from the target.

16-20. (canceled)

21. A device, comprising:
a photonic substrate comprising a first surface coupler, a second surface coupler, and an interference coupler;
a surface emitting laser mounted on the photonic substrate, the surface emitting laser is configured to emit polarized light having a first polarization; and
a set of photodetectors, wherein:
the surface emitting laser is positioned to emit the polarized light toward the photonic substrate;
the first surface coupler is positioned to capture a first portion of the polarized light as local oscillator light and pass a second portion of the polarized light that exits the photonic substrate as emitted signal light;
the second surface coupler is positioned to receive reflected signal light that is reflected and capture a portion of the reflected signal light having a second polarization as collected signal light;
the interference coupler optically interferes the local oscillator light with the collected signal light to generate a set of optical outputs; and
the set of photodetectors measures the set of optical outputs.

22. The device of claim 21, wherein:
the photonic substrate comprises a first waveguide layer and a second waveguide layer;
the first surface coupler is formed in the first waveguide layer; and
the second surface coupler is formed in the second waveguide layer.

23. The device of claim 22, wherein:
the first waveguide layer and the second waveguide layer are formed from different materials.

24. The device of claim 21, wherein:
The first surface coupler is positioned between the second surface coupler and the surface emitting laser.

25. The device of claim 21, wherein:
the photonic substrate comprises a polarization rotator configured to convert the local oscillator light from the first polarization to the second polarization.
